(19) United States
(12) Patent Application Publication
(10) Pub. No.: US 2006/0176012 A1
(43) Pub. Date: Aug. 10, 2006

(54) Battery pack locking apparatus for mobile terminal

(75) Inventors: Seung-Chul Lee, Suwon-si (KR); Yu-Chul Chang, Anyang-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD, Suwon-si (KR)

(21) Appl. No.: 11/174,822

(22) Filed: Jul. 5, 2005

(30) Foreign Application Priority Data
Feb. 4, 2005 (KR) 10871-2005

(51) Int. Cl. H02J 7/00

(52) U.S. Cl. 320/107

(57) ABSTRACT

Disclosed herein is a battery pack locking apparatus for a mobile terminal, in which a battery pack is mounted to a lower case frame of the mobile terminal. The apparatus includes a hook unit provided to a lateral side of the lower case frame, and a side locking unit provided in place of the battery pack and disposed at a position corresponding to the hook unit, in which the side locking unit is slid in a longitudinal direction of the lower case frame so as to be engaged with the hook unit or disengaged from the hook unit, thereby attaching or detaching the battery pack to or from the lower case frame.

### PRIORITY

This application claims priority to an application entitled “Battery Pack Locking Apparatus For Mobile Terminal” filed in the Korean Industrial Property Office on Feb. 4, 2005 and assigned Serial No. 2005-10871, the contents of which are incorporated herein by reference.

### BACKGROUND OF THE INVENTION

1. Field of the Invention

The present invention relates to a battery pack locking apparatus for a mobile terminal, and more particularly, to a battery pack locking apparatus having a side locking unit for latching or unlatching a battery pack to or from a mobile terminal.

2. Description of the Related Art

In general, a mobile terminal has a battery pack 10 detachably mounted to a rear side of a terminal body 1, as a power source, as shown in FIG. 1. The battery pack 10 is latched to or unlatched from the terminal body by a locking unit 20 installed to the rear side of the terminal body.

The battery pack 10 is generally mounted to the rear side of the terminal body 1 by slidably mounting the battery pack mounted by guide ribs, or by catching one end of the battery pack to a locking member, and then moving the battery pack is downward and locking.

Terminals (not shown) are exposed from lower portions of front and rear sides of the battery pack 10. The terminals provided to one side of the battery pack 10 are in contact with connecting terminals (not shown) protruded from the rear side of the body 1. The terminals provided to the other side of the battery pack 10 are in contact with connecting terminals (not shown) of a battery charger when charging.

As shown in FIG. 1, a conventional apparatus of locking a pop-up type of the battery pack 10 for use in a mobile terminal connects the battery pack 10 to the rear side of the body 1 consisting of a lower chasing frame 1a. The lower casing frame 1a is provided at a rear side thereof with a locking unit 20 for latching the battery pack 10 to the body.

When mounting the battery pack 10 to the body 1, the battery pack 10 is firstly connected to the rear side of the body 1. The locking unit 20 is provided with a locker 21 locking in a recess 11 (FIG. 2) formed at the battery pack 10. As a result, the battery pack 10 is firmly secured to the body 1 by the locker 21. To release the battery pack 10 from the body 1, the locker 21 is released from the recess 11 of the battery pack 10 by pulling the locker 21 exposed to the exterior, so that the battery pack is detached from the body 1.

As shown in FIG. 2, which shows a conventional battery pack locking apparatus, the apparatus is mounted to a lower casing frame 1a of a terminal body 1, and includes at least one guide rib 23 for guiding a battery pack in a pop-up direction.

A spring 30 is utilized to provide the locker 21 with constant resilient force. The spring 30 is installed such that one end of the spring is supported by the lower casing frame 1a to press the locker 21.

In the structure of a sliding type of a conventional battery pack locking apparatus, a battery pack is slidably mounted in a battery holder provided to a rear side of a terminal body, and is latched or unlatched by a locking unit installed to the body.

However, since the pop-up type of the conventional battery pack locking apparatus for the mobile terminal is adapted to pop up the battery pack from the terminal by pulling the locker of the locking unit 20 provided in the body in a vertical direction, a separate space 70 (FIG. 3) in the body is required for accommodating the locking unit. Components such as an antenna 60 are mounted to a position adjacent to the space 70. Therefore, a thickness of the terminal is increased by the locker, which interfering with the ability to slim-down and scale-down the terminal. In addition, there are limited options to vary the appearance of the terminal due to the protruded locker.

Furthermore, the conventional sliding-type battery pack locking apparatus for the mobile terminal is adapted to connect and disconnect the battery pack by pushing or pulling a locking tap provided to the body. If the battery pack is not accurately connected to the body, the battery pack is easily detached from the body.

### SUMMARY OF THE INVENTION

Accordingly, the present invention has been made to solve the above-mentioned problems contained in the conventional apparatus, and an object of the present invention is to provide a battery pack locking apparatus having a side locking unit for latching or unlatching a battery pack to or from a mobile terminal, in which there is not required a mounting space for a locking unit to slim and miniaturize the mobile terminal.

Another object of the present invention is to provide a battery pack locking apparatus having a side locking unit for latching or unlatching a battery pack to or from a mobile terminal, in which a user can conveniently connected or disconnect the battery pack to or from the terminal using one hand.

Still another object of the present invention is to provide a battery pack locking apparatus having a side locking unit for latching or unlatching a battery pack to or from a mobile terminal, in which an existing mounting space for a locking unit in the terminal can be mounted with other components to improve efficiency of spacing.

In order to accomplish this object, there is provided a battery pack locking apparatus for a mobile terminal, in which a battery pack is mounted to a lower case frame of the mobile terminal, the apparatus includes a hook unit provided to a lateral side of the lower case frame; and a side locking unit provided in place of the battery pack and disposed at a position corresponding to the hook unit, such that the side locking unit is slid in a longitudinal direction of the lower case frame so as to be engaged with the hook unit or disengaged from the hook unit, thereby attaching or detaching the battery pack to or from the lower case frame.

### BRIEF DESCRIPTION OF THE DRAWINGS

The above and other objects, features and advantages of the present invention will be more apparent from the following detailed description taken in conjunction with the accompanying drawings, in which:

FIG. 1 is a plan view of a pop-up type of a conventional battery pack locking apparatus for a mobile terminal;

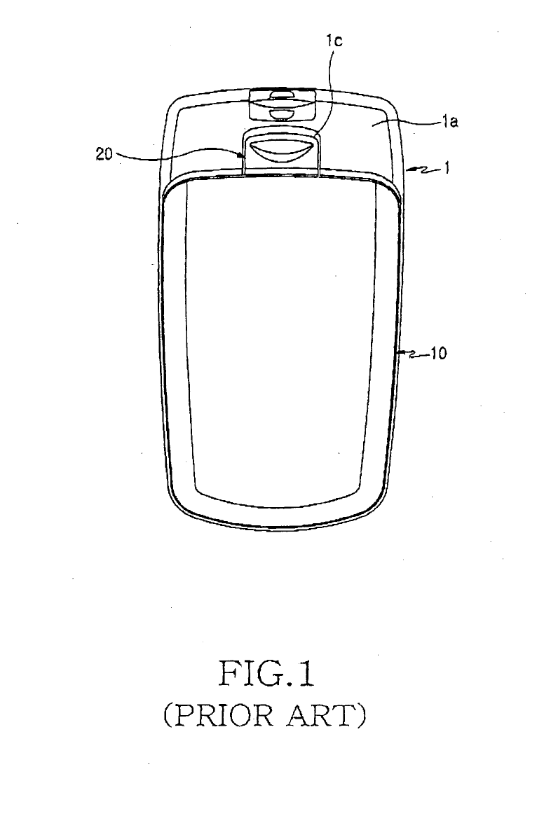

FIG. 2 is a cross-sectional view illustrating a construction of a pop-up type of a conventional battery pack locking apparatus for a mobile terminal;

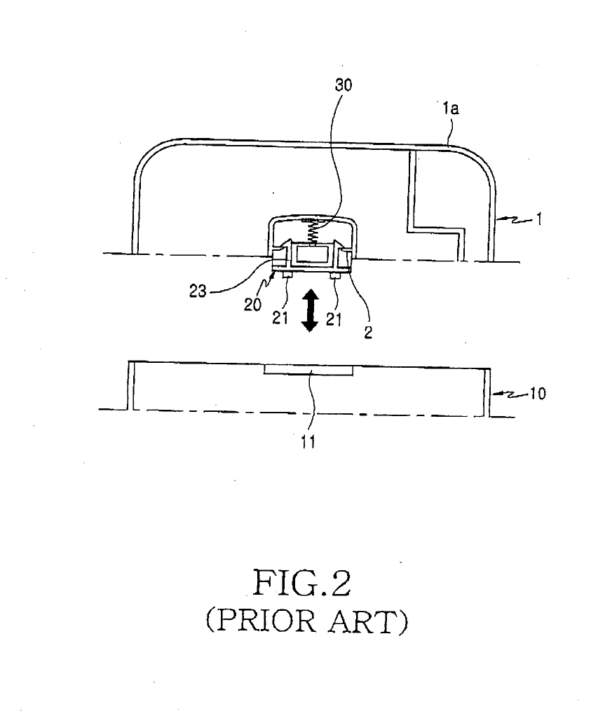

FIG. 3 is an exploded perspective view illustrating a rear side of a lower case frame of a conventional mobile terminal;

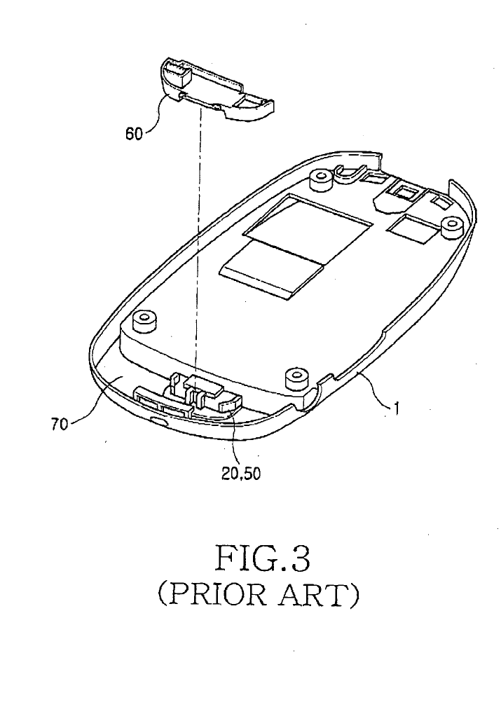

FIG. 4 is an exploded perspective view illustrating a construction of a battery pack locking apparatus for a mobile terminal according to an embodiment of the present invention;

FIG. 5 is a perspective view illustrating a battery pack connected to a battery pack locking apparatus for a mobile terminal according to an embodiment of the present invention;

FIG. 6 is a plan view illustrating a battery pack connected to a battery pack locking apparatus for a mobile terminal according to an embodiment of the present invention;

FIG. 7 is a partially cutaway view in perspective of a battery pack connected to a battery pack locking apparatus for a mobile terminal according to an embodiment of the present invention;

FIG. 8 is a perspective view illustrating a state before unlocking of a battery pack locking apparatus for a mobile terminal according to an embodiment of the present invention operates;

FIG. 9 is a perspective view illustrating an operating process of a battery pack locking apparatus for a mobile terminal according to an embodiment of the present invention;

FIG. 10 is a perspective view illustrating a state after unlocking of a battery pack locking apparatus for a mobile terminal according to an embodiment of the present invention operates; and

FIG. 11 is a perspective view illustrating a rear side of a lower case frame of a mobile terminal in a battery pack locking apparatus for the mobile terminal according to an embodiment of the present invention.

### DETAILED DESCRIPTION OF THE PREFERRED EMBODIMENTS

Hereinafter, preferred embodiments of the present invention will be described with reference to the accompanying drawings. In the following description, the same elements will be designated by the same reference numerals although they are shown in different drawings.

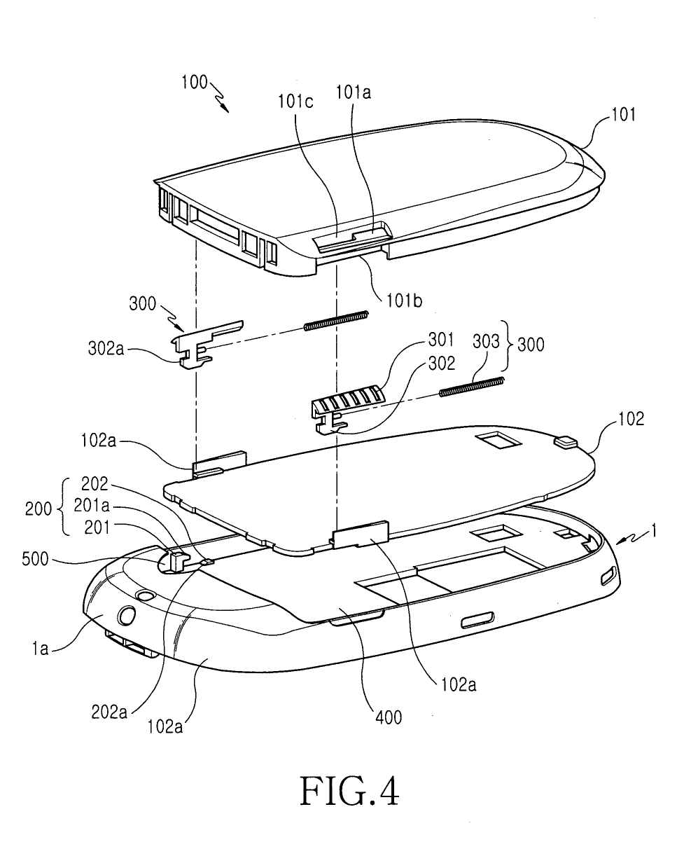

Referring to FIG. 4, a battery pack locking apparatus 100 includes a hook unit 200 and a side locking unit 300. The hook unit 200 is provided to a lateral side of a lower case frame 1a of a mobile terminal 1 to be latched to or unlatched from the side locking unit 300. The side locking unit 300 is provided adjacent to the battery pack 10 such that the side locking unit 300 is slid in a longitudinal direction of the lower case frame 1a so as to be engaged with or disengaged from the hook unit 200, thereby attaching or detaching the battery pack 10 to or from the lower case frame 1a.

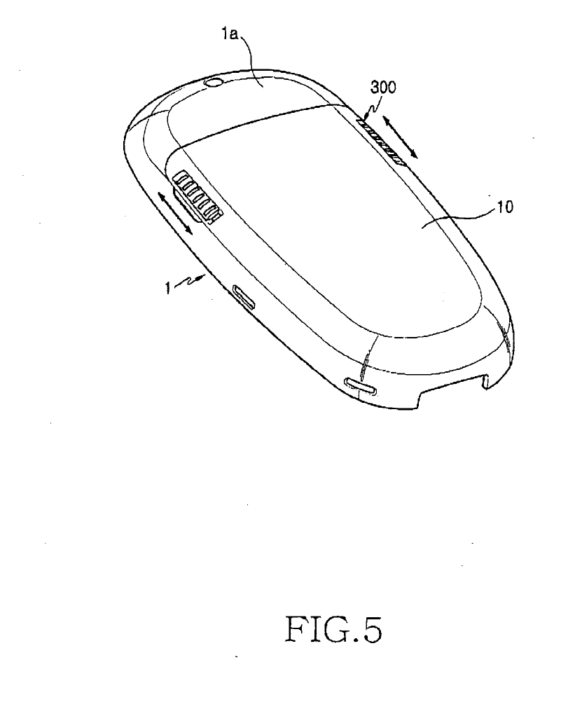

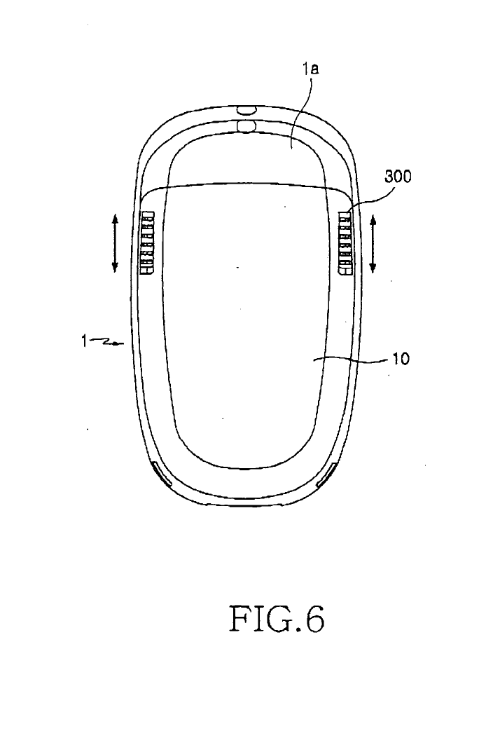

Referring to FIGS. 4, 5 and 6, the side locking unit 300 is provided at a position corresponding to the hook unit 200. The lower case frame 1a is formed with a mounting surface 400 to which the battery pack 10 is mounted. At least one hook unit 200 is provided at the lateral side of the mounting surface 400.

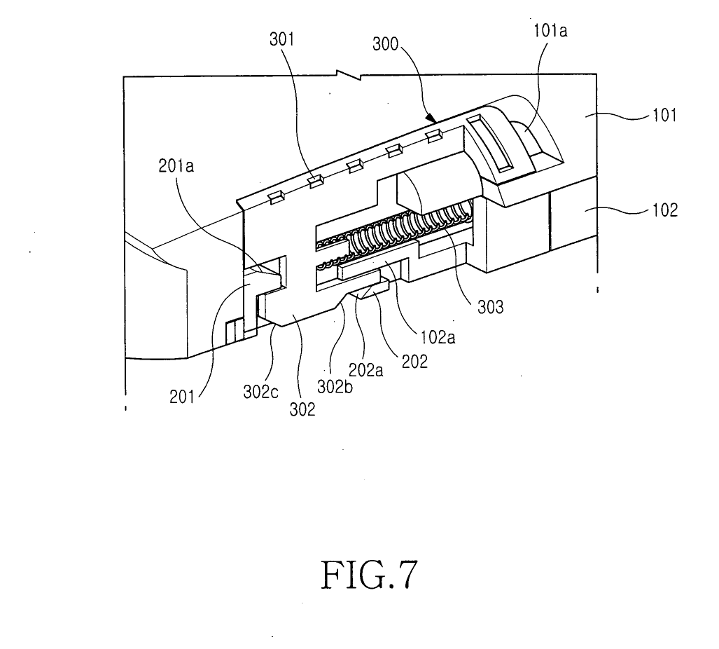

Referring to FIG. 7, the hook unit 200 is provided with a hook member 201 engaging with a sliding/up locking portion 302 formed at the side locking unit 300. Also, the hook unit 200 is provided at a position adjacent to the hook member 201 with a guide 202 for guiding the side locking unit 300 to vertically lift the side locking unit 300. The guide 202 is positioned opposite to the hook member 201.

As shown in FIG. 7, the hook member 201 and the guide 202 are provided with guide surfaces 201a and 202a for guiding slide and lift of first and second inclined guide surfaces 302b and 302c formed at the side locking unit 300.

Referring to FIG. 4, the battery pack 10 consists of upper and lower cases 101 and 102. The upper case 101 is provided at both sides thereof with a side mounting portion 101a for mounting the side locking unit 300. The lower case 102 is provided at both sides thereof with a guide member 102a engaging with the side locking unit 300 to guide the slide of the side locking unit or support the side locking unit.

Referring to FIGS. 4 and 7, the side mounting portion 101a is formed with a recessed portion 101b for sliding the side locking unit 300. The recessed portion 101b is formed with an engaging hole 101c through which the side locking unit 300 penetrates.

As shown in FIGS. 4, 5 and 6, at least one side locking unit 300 is mounted to the side mounting portion 101a in a longitudinal direction.

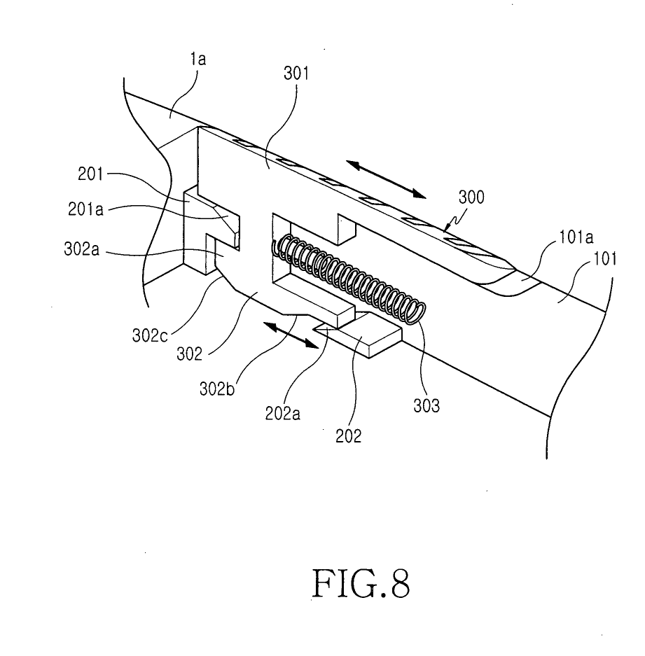

Referring to FIGS. 8, 9 and 10, the side locking unit 300 includes a side button 301, a sliding/up locking portion 302, and a coil spring 303. The side button 301 is provided in the recessed portion 101b of the battery pack 10 so that the side button is exposed from the exterior and is slid in a longitudinal direction of the battery pack 10. The sliding/up locking portion 302 is formed under the side button 301 so that it can be connected to or disconnected from the hook unit 200 of the lower case frame 1a by sliding the button 301 in the longitudinal direction. The sliding/up locking portion 302 is interposed between the hook member 201 and the guide 202. The coil spring 303 is provided to the sliding/up locking portion 302 to slide the sliding/up locking portion 302 in the longitudinal direction with a pressing force.

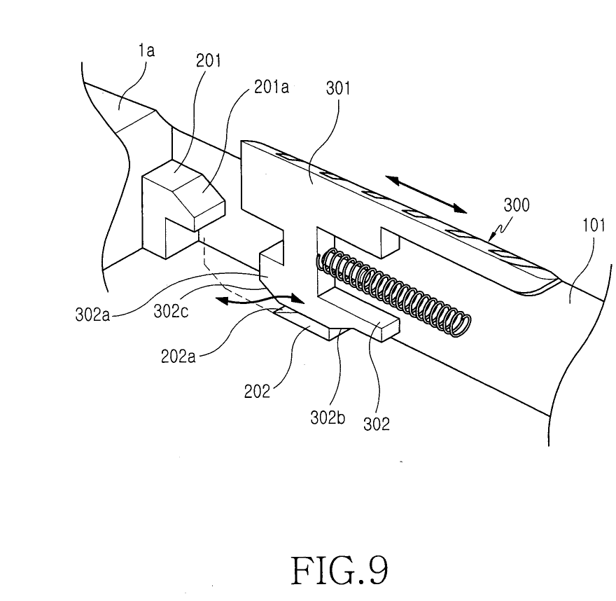

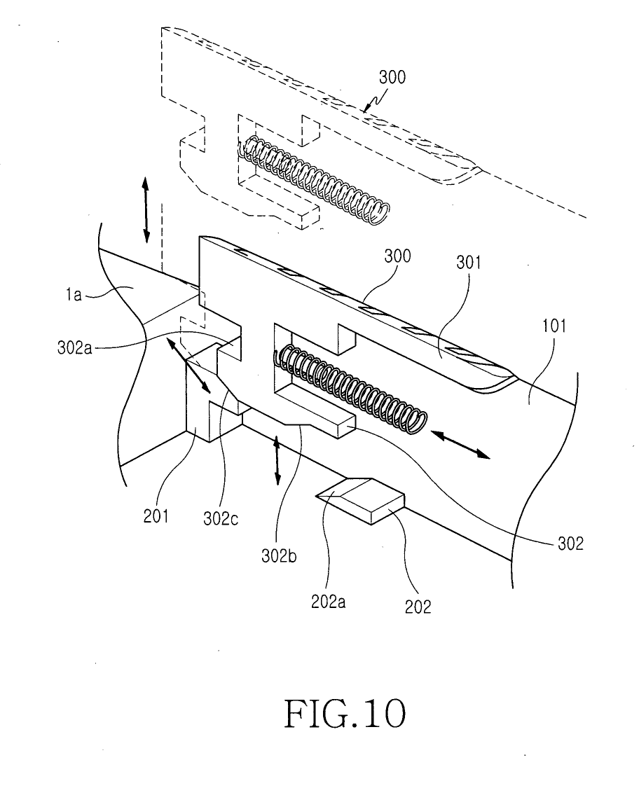

Referring to FIGS. 9 and 10, the sliding/up locking portion 302 is provided with a locking member 302a engaged with or disengaged from the hook member 201 of the hook unit 200. The sliding/up locking portion 302 is formed with a first inclined guide surface 302b at one end thereof. As a result, when the side button 301 is slid in the longitudinal direction, the sliding/up locking portion 302 can lift in a direction perpendicular to the longitudinal direction. Meanwhile, the sliding/up locking portion 302 is formed with a second inclined guide surface 302c at the other end thereof. As a result, the lifted sliding/up locking portion 302 is slid in a reverse direction by the resilient force of the coil spring 303, and comes in contact with the guide surface 201a of the hook member 201, thereby moving up the battery pack 10 from the mounting surface 400 of the lower case frame 1a.

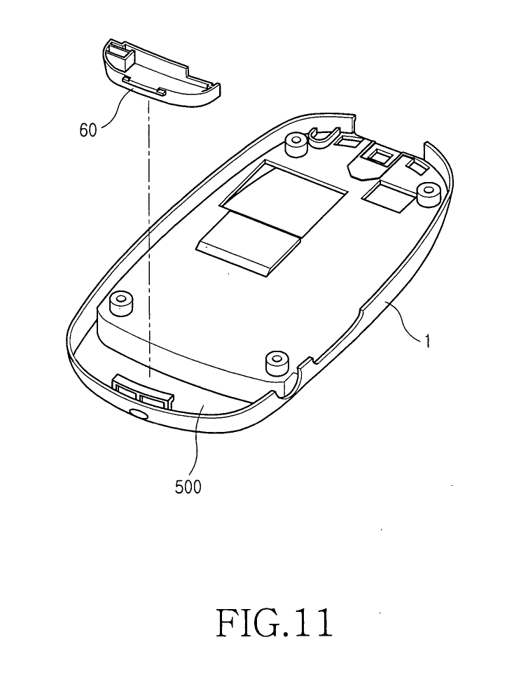

Referring to FIG. 11, the lower case frame 1a of the terminal 1 is provided at a center thereof with a mounting space 500 to mount components, such as antenna 60, performance of which is in proportion to a volume.

Operation of the battery pack locking apparatus for the mobile terminal according to the embodiment of the present invention will now be described in detail with reference to FIGS. 4 through 11.

As shown in FIG. 4, the lateral side of the battery pack 10 is provided with the side locking unit 300 so as to mount the battery pack 10 to the lower case frame 1a of the mobile terminal 1, and the side locking unit 300 is slidingly moved and lifted from the mounting surface 400 of the lower case frame 1a.

Referring to FIGS. 4, 5 and 6, the battery pack 10 consists of the upper and lower cases 101 and 102, and the upper case 101 is provided at both sides thereof with the side mounting portion 101a for mounting the side locking unit 300. As a result, the side locking unit 300 is mounted to the side mounting portion 101a.

As shown in FIG. 4, since the side mounting portion 101a is formed with the engaging hole 101c through which the side locking unit 300 penetrates, the sliding/up locking portion 302 is fitted and engaged with the engaging hole 101c, and simultaneously, the side locking unit 300 is mounted in the recessed portion 101b formed at the side mounting portion.

In this case, the lower case 102 is engaged with the upper case 101 of the battery pack 10.

As shown in FIG. 7, since the lower case 102 is provided at both sides thereof with the guide member 102a engaging with the side locking unit 300 to guide the slide of the side locking unit or support the side locking unit, the locking portion 302 of the side locking unit 300 is engaged with the guide member 102a.

When the battery pack 10 is detached from the lower case frame 1a of the terminal 1, the side button 301 of the side locking unit 300 provided to the lateral side of the battery pack 10 is slid in the longitudinal direction by pulling it with a finger of a user.

As shown in FIG. 9, when the side button 301 is slid, the sliding/up locking portion 302 is also slid.

When the sliding/up locking portion 302 is slid, the guide surface 202a of the guide portion 202 comes in contact with the first inclined guide surface 302b formed at one end of the sliding/up locking portion 302 to lift the sliding/up locking portion 302 in a direction perpendicular to the longitudinal direction.

At that time, as shown in FIG. 10, the locking member 302a of the sliding/up locking portion 302 is released from the hook member 201, and the sliding/up locking portion 302 is slid in a reverse direction by the resilient force of the coil spring 303 provided in the sliding/up locking portion 302. At that time, the second inclined guide surface 302c formed at the other end of the sliding/up locking portion comes in contact with the guide surface 201a of the hook member 201, and simultaneously, the battery pack 10 is protruded and detached from the mounting surface 400 of the lower case frame 1a.

As shown in FIG. 8, in this case where the battery pack 10 is again engaged with the lower case frame 1a of the terminal 1, the lower end of the battery pack 10 is engaged with one end of the lower case frame 1a, and the side locking unit 300 of the battery pack 10 is engaged with the hook unit 200 provided to the frame 1a.

At that time, the sliding/up locking portion 302 of the side locking unit 300 cones in contact with the guide surface 201a of the hook member 201, and is again slid in a direction perpendicular to the longitudinal direction, so that the locking member 302a of the sliding/up locking portion 302 is engaged with the hook member 201.

As described above, since the battery pack locking apparatus is provided with the side locking unit around the lateral side of the terminal to latch or unlatch the battery pack to or from the terminal, the connection or disconnection of the battery pack is convenient, and the mounting space of the locking unit provided at the center of the terminal may be mounted with other components, such as antenna, which can improve performance in proportion to its volume.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A battery pack locking apparatus for a mobile terminal, in which a battery pack is mounted to a lower case frame of the mobile terminal, the apparatus comprising:
a hook unit provided to a lateral side of the lower case frame; and
a side locking unit provided adjacent to the battery pack and disposed at a position corresponding to the hook unit, in which the side locking unit is slid in a longitudinal direction of the lower case frame so as to engage with the hook unit or disengage from the hook unit, thereby attaching or detaching the battery pack to or from the lower case frame.

2. The battery pack locking apparatus as claimed in claim 1, wherein the lower case frame is formed with a mounting surface to which the battery pack is mounted and the hook unit is provided around the lateral side of the mounting surface.

3. The battery pack locking apparatus as claimed in claim 1, wherein the hook unit comprises:
a hook member engaging with the side locking unit; and
a guide disposed opposite to the hook member for guiding the side locking unit to lift the side locking unit in a direction perpendicular to the longitudinal direction.

4. The battery pack locking apparatus as claimed in claim 3, wherein the hook member and the guide are provided with guide surfaces for guiding slide and lift of the side locking unit.

5. The battery pack locking apparatus as claimed in claim 1, wherein the battery pack consists of upper and lower cases, in which the upper case is provided at both sides thereof with a side mounting portion for mounting the side locking unit, and the lower case is provided at both sides thereof with a guide member engaging with the side locking unit to guide the slide of the side locking unit or support the side locking unit.

6. The battery pack locking apparatus as claimed in claim 5, wherein the side mounting portion is formed with a recessed portion for sliding the side locking unit therein, in which the recessed portion is formed with an engaging hole, through which the side locking unit penetrates.

7. The battery pack locking apparatus as claimed in claim 5, wherein at least one side locking unit is mounted to the side mounting portion in a longitudinal direction.

8. The battery pack locking apparatus as claimed in claim 1, wherein the side locking unit comprises:
a side button provided in the recessed portion of the battery pack to expose the side button and to allow sliding in a longitudinal direction of the battery pack;
a sliding/up locking portion formed on the side button for connecting to or disconnecting from the hook unit of the lower case frame by sliding the button in the longitudinal direction; and
a coil spring provided to the sliding/up locking portion to slide the sliding/up locking portion in the longitudinal direction with a pressing force.

9. The battery pack locking apparatus as claimed in claim 8, wherein the sliding/up locking portion is further provided with a locking member engaged with or disengaged from the hook member of the hook unit.

10. The battery pack locking apparatus as claimed in claim 8, wherein the sliding/up locking portion is formed with a first inclined guide surface at one end thereof, in which when the side button is slid in the longitudinal direction, the sliding/up locking portion lifts in a direction perpendicular to the longitudinal direction, and
the sliding/up locking portion is formed with a second inclined guide surface at an other end thereof, in which the lifted sliding/up locking portion is slid in a reverse direction by pressing force of the coil spring, and comes in contact with the guide surface of the hook member, thereby moving up the battery pack away from the mounting surface of the lower case frame.

11. The battery pack locking apparatus as claimed in claim 1, wherein the lower case frame of the terminal is provided at a center thereof with a mounting space to mount components including an antenna.
